(19) United States
(12) Patent Application Publication
(10) Pub. No.: US 2026/0350918 A1
(43) Pub. Date: Nov. 5, 2026

(54) METHOD AND DEVICE FOR MATCHING REAL AND VIRTUAL CONTENT OF A SCENE

(71) Applicant: K5 Lux AI GmbH, München (DE)

(72) Inventor: Clarens Grollmann, München (DE)

(21) Appl. No.: 19/662,747

(22) Filed: Apr. 29, 2026

(30) Foreign Application Priority Data
Apr. 30, 2025 (DE) 10 2025 116 748.6

(51) Int. Cl. G06T 15/50; G06T 7/73; G06T 17/20; H04N 5/222

(52) U.S. Cl. CPC G06T 15/506; G06T 7/73; G06T 17/20; G06T 2207/10012; G06T 2207/10024; G06T 2207/10028; G06T 2210/56; H04N 5/2224

(57) ABSTRACT

Disclosed is a method for matching real and virtual contents of a scene, including providing a real light source, providing information about the light source to a control device, detecting a position of a real object and/or its lighting situation, generating a three-dimensional simulation model of the real scene, generating a three-dimensional model of a virtual scene suitable to be displayed on an image output unit with a screen, detecting the relative position of the screen with respect to the at least one real light source and/or to the real object, combining the simulation model of the real scene with the model of the virtual scene so that a transition from the real scene to the virtual scene takes place on the display surface, and detecting the real scene and the virtual scene, at least section by section, by a signal receiver. A corresponding device is also disclosed.

### CROSS REFERENCE TO RELATED APPLICATION

This application claims priority to German Patent Application No. 10 2025 116 748.6, filed in Germany on Apr. 30, 2025, the entire contents of which are hereby incorporated herein by this reference.

### FIELD

The present invention relates to a method for matching real and virtual content of a scene.

### BACKGROUND

Film sets are known from the prior art, for example, for producing feature films or TV series, in which a real film scene is set up in front of a virtual film scene displayed on a projection screen, in order to create the impression that the real film scene continues into the virtual film scene.

To convincingly convey this impression, it is currently necessary to plan and execute the lighting arrangement (positioning of light sources and the reciprocal lighting effects of scene objects, such as shadows) in the real scene and in the virtual scene independently of one another in order to display the corresponding virtual film scene on the screen at the time of filming. Current systems are generally not able to react in real time or near real time to changing situations in the real film scene, particularly with regard to changing lighting situations of the real film scene, which would have to be carried over into the virtual film scene, during the lighting setup or filming.

### SUMMARY

The object of the present invention is therefore to provide a method for matching real and virtual content of a scene, which makes it possible to combine a real film scene and a virtual film scene in an improved way and thus create, for example for actors in the real film scene and/or viewers/signal receivers of the real scene, a more realistic transition between the real film scene and the virtual film scene.

This object is achieved according to the present invention by a method for matching real and virtual content of a scene, wherein the method comprises the following steps:
Providing at least one real light source in the real scene,
Providing information about the at least one real light source to a control device, wherein the information includes at least one of the following: a principal emission direction, emission cone, emission color spectrum, and emission brightness of the at least one real light source,
Detecting a position of a real object in the real scene relative to the at least one real light source and/or a lighting situation of the real object in the real scene based on the light emitted by the at least one real light source,
Generating, by means of the control device, a three-dimensional simulation model of the real scene, which includes at least one of the following: information about the at least one real light source, the position of the real object relative to the at least one real light source, and the lighting situation of the real object,
Generating a three-dimensional model of a virtual scene, which is suitable for display on an image output unit using a screen suitable for the display, wherein the model of the virtual scene contains at least information regarding a position of a virtual object relative to the screen,
Detecting a relative position of the screen with respect to the at least one real light source and/or to the real object,
Combining the simulation model of the real scene with the model of the virtual scene, such that a transition from the real scene to the virtual scene takes place at the screen in such a way that the lighting situation of the real object is continued into the representation of the virtual scene by the image output unit at the screen, and
Detecting the real scene and the virtual scene at least section by section by a signal receiver.

In this connection it should be noted that, within the scope of the present invention, the term “signal receiver” can refer to both technical and human signal receivers or message receivers. Such a signal receiver can thus include a camera, in particular a production camera, for recording images and/or a human sensory perception, in particular the human eye.

Furthermore, it should be mentioned that the “principal emission direction” can be understood, for example, as a direction parallel or concentric to a central axis of the emission cone or parallel or concentric to an axis that is aligned orthogonally with a light outlet surface of the light source, in particular at a point central to an edge of the light outlet surface.

A “lighting situation” can in particular include information about a shadow cast by the object, which is generated, for example, by the illumination of the at least one light source, the casting of a shadow being mentioned merely by way of example. Other light changes caused by the real object may also be equally relevant and can be transferred to the virtual scene in an equivalent way by the method described here. Another such example is the reflection of light on a reflective or shiny surface.

A “scene,” as used here, could be, for example, a film scene or a scene from a live event, such as in the context of e-sports or organized immersive events.

Detecting the relative position of the screen can include detecting a distance from a center point and/or a focal point of the screen and/or at least one point located on an outer contour of the screen to the at least one real light source and/or to the real object. In particular, detecting the relative position of the screen, given knowledge of the geometry of the screen, can include detecting a distance from the at least one real light source and/or the real object to an arbitrary point on the screen.

The method according to the invention thus makes it possible to execute a transition between the real scene and the virtual scene in such a way that a substantially seamless transition is created for the signal receiver. For example, a shadow which is cast by the illumination of the real object by the at least one real light source, and which extends to the screen, can be taken into account in the representation of the virtual scene on the screen in such a way that the shadow continues seamlessly and in a realistic manner from the real scene into the virtual scene. If the lighting situation in the real scene changes, for example, by shifting the at least one real light source, then the changing shadow cast in the real scene can be immediately transferred to the representation of the virtual scene by the method according to the invention, for example, in real time or at least nearly in real time.

In order to be able to realistically calculate the representation of a shadow cast by an object, but not limited to this objective, the step of detecting the position of the real object relative to the at least one real light source can further include detecting a geometry of the real object, viewed at least from the perspective of the at least one real light source on the real object. The geometry of the real object can include, for example, a size and/or an outer contour and/or a shape, in particular three-dimensional shape, and/or a surface structure of the real object. Knowing the geometry of the real object means that a shadow of the object or another effect on the light caused by the object can be calculated more accurately when calculating the simulation model of the real scene and/or when calculating the model of the virtual scene.

The information about the virtual object can furthermore include its geometry, and/or radiation properties and/or reflection properties and/or degree of transparency and/or color and/or structure of the virtual object. In a similar way to detecting the geometry of the real object, information about the geometry of the virtual object can also be used to calculate more accurately the lighting situation in connection with the virtual object, for example a shadow cast by this object. The illumination of the virtual object can originate from the at least one real light source and/or from a virtual light source. Also, information regarding reflection properties and/or degree of transparency, and/or color, and/or structure of the virtual object can be used to calculate the lighting situation existing in the virtual scene even more realistically. Furthermore, based on the information about the virtual object, how the lighting situation in the virtual scene might affect the real scene can thus be calculated, so that the corresponding light output of the display unit can be adjusted accordingly. In other words, the method according to the invention can be suitable for taking into account the effects of the real scene on the virtual scene and/or the effects of the virtual scene on the real scene. In particular, as regards the effects of the lighting situation of the virtual scene on the real scene, but also as regards the lighting situation within the virtual scene, a radiation property of the virtual object, for example, as a virtual light source, can be important. For example, in the case where the virtual object has a highly reflective, especially shiny, surface, illumination of the virtual object by a real and/or virtual light source can produce a lighting situation via the virtual object that is very similar to what would be the case if the virtual object itself were a virtual light source.

In a further development of the present invention, the at least one real light source and/or the signal receiver and/or the real object can be connected to a tracking system. The tracking system can be configured in particular, depending on which component the tracking system is connected to, to enable at least one of the following to be detected:
the position and/or the orientation of the at least one real light source relative to the screen and/or relative to the signal receiver and/or relative to the real object, and/or
the position and/or the orientation of the signal receiver relative to the screen and/or relative to the real object and/or relative to the at least one real light source, and/or
the position and/or the orientation of the real object relative to the screen and/or relative to the signal receiver and/or relative to the at least one real light source.

The information thus detected can in turn form at least part of the information needed to create the simulation model of the real scene.

The tracking system can act as a passive tracking system, which operates based on light reflected from the component being tracked, in particular from a tracking unit attached to it, especially retroreflected infrared light, and/or as an active tracking system, which is designed to actively emit a signal, for example a light signal or an electromagnetic signal.

By providing a tracking system and consequently detecting the position and/or orientation of the component connected thereto, this information is immediately available in digital form and can be directly employed in a calculation of the simulation model of the real scene and/or the model of the virtual scene.

Alternatively or additionally, the step of detecting the position of a real object in the real scene can include the use of a depth information detection device, which is designed to obtain depth information at least on sections of the real scene. In other words, a depth information detection device can be used instead of, or in addition to, using a tracking system. Thus, depth information about one and the same real object in the scene using the depth information detection device and information about its position and/or orientation using the tracking system can be collected. Of course, if the real scene is considered as a whole, it is conceivable that information about different components of the scene could be collected using different detection devices.

For example, a depth map can be generated from recorded camera images, in particular by using stereo triangulation and/or photogrammetric methods and/or by means of depth sensors (e.g., time-of-flight sensors), and a three-dimensional simulation model of the real scene can be calculated based on this information.

The depth information detection device can, in particular, comprise a stereoscopic camera pair, which includes at least one HDR camera, and/or a LIDAR unit and/or an RGB-D unit. This list should not be understood as exhaustive, and other suitable systems can also be used as depth information detection devices.

The depth information detection device can in particular be configured to use a photogrammetric recording technique to generate the simulation model of the real scene. For example, a plurality of cameras can be used for this purpose, which are configured to capture the real scene from different perspectives and/or viewing directions. Accordingly, the generated simulation model can reflect a geometry of the real scene almost completely or even completely, especially compared to a model generated using a depth map. Masking due to by depth cameras can be avoided in the simulation model generated by photogrammetric recording techniques. Thus, for example, the shadow cast by a spatially extended object can be simulated more realistically, since the complete object geometry is known.

Alternatively or additionally, the depth information acquisition system can be configured to use an AI-based computational method, in particular NeRF or Gaussian splatting, to generate the simulation model of the real scene. An AI-based computational method can be especially suitable to detect not only a 3D model of the scene (as is already the case with photogrammetry) but also material properties such as reflectivity, roughness, and/or transparency of the surfaces (see also the descriptions hereinbefore and hereinafter), thereby enabling a more realistic representation to be obtained with regard to the light-shaping properties of the real scene. For example, reflective surfaces can be recognized as such by this computational method. Consequently, the model can reflect the incident light physically correctly.

In this connection, the depth information detection device can be connected to a tracking system that is configured to enable the position and/or orientation of the depth information detection device to be detected relative to the screen and/or relative to the real object and/or relative to at least one real light source, wherein the position and/or orientation of the depth information detection device form part of the information used to create the simulation model of the real scene. In a manner analogous to the tracking system described above, which is explicitly referred to here, the position and/or orientation of the depth information detection device, and in particular any changes thereto, can also be directly captured digitally and thus processed during a (e.g., renewed) creation of the simulation model of the real scene.

The method may further comprise the following steps:
providing a digital luminaire model of the at least one real light source, which includes information relating to at least one of the following: a principal emission direction, emission cone, emission color spectrum and emission brightness of the at least one real light source, and
integrating the digital luminaire model in the step of generating the three-dimensional simulation model of the real scene.

In particular, the provision and integration of the digital luminaire model may alternatively or additionally be intended to detect information relating to the at least one real light source, such as information relating to an emission direction and/or emission cone and/or emitted color spectrum and/or brightness, and the like. For example, it may be sufficient to know a position and/or orientation and/or lighting settings of the real light source, in particular without having to determine them via an external unit, and to send this information to the digital luminaire model in order to be able to generate the three-dimensional simulation model of the real scene corresponding to the actual existing situation.

In particular, the steps of the method can be repeated, wherein the method can be designed to reflect changes in the real scene, especially in real time, in the generation of an updated three-dimensional simulation model of the real scene and thus in an updated representation of the virtual scene by the image output unit on the screen. In order to be able to convincingly influence a viewer, regardless of whether the viewer is viewing the scene directly or via recorded material, that they do not perceive a transition from the real scene to the virtual scene, or at least do not find it intrusive, it can be particularly advantageous if a change in the real scene has a direct effect on the virtual scene. The same can of course apply to the reverse case, where a change in the virtual scene has a direct effect on the real scene. By means of an iterative recalculation of the three-dimensional simulation model of the real scene and/or the model of the virtual scene, the two scenes can be directly matched to one another, so that the viewer has the impression of an actual interaction between the real scene and the virtual scene, and in this way the transition between the two scenes can be canceled.

The image output unit can comprise at least one LED wall, a computer screen, a television screen, and a projection wall, wherein the screen of the image output unit can in particular be substantially flat or curved and/or have a rectangular, round, oval or polygonal outer contour. The screen of the image output unit can also comprise several adjacent or overlapping sections, which can have different sizes and/or shapes.

Advantageously, the image output unit can be designed to emit directional light, wherein, in particular, separate sections of the image output unit can be configured so as to emit light in different directions in each case. In contrast to emitting light in a diffuse manner across the screen of the image output unit, emitting light in a directed manner across the screen of the image output unit means that the lighting conditions present in the virtual scene can be transferred more accurately to the real scene. For example, the light emitted virtually by a virtual light source, such as a virtual spotlight, a virtual fire, or virtual sunlight, can be displayed on the screen of the image output unit in such a way that a real object exhibits a lighting situation (e.g., shadows, reflections, etc.) that corresponds to the lighting situation under which the real object would be illuminated by the real counterpart of the virtual light source.

For this purpose, the image output unit can be designed using light field technology, such that the image output unit is configured to emit appropriately directed light. Furthermore, it can be envisaged that the light emitted by the virtual light source is calculated using a ray-tracing method in order to determine the light emission direction of the image output unit, in particular the light emission direction of the respective light emission units of the image output unit.

The step of detecting the position of a real object within the real scene can include detecting a point cloud whose points are arranged at least on a surface of the real object, and/or detecting a grid model, wherein the grid model in its three-dimensional form is able, at least approximately depending on the mesh size of the grid model, to correspond to a surface of the real object. Thus, for each point in the point cloud a distance to, for example, an associated depth information detection device and/or, if desired, to another reference point, such as the screen, can be detected, and thereby a three-dimensional digital image of the section of the real scene can be generated that has been scanned by the point cloud. The same applies to a depth information detection device designed to use a grid model instead of a point cloud to generate digital three-dimensional information about a real object or a section of the real scene. It is also conceivable to set up a corresponding depth information detection device that first of all uses a point cloud to scan a section of the real scene and then connects the points in such a way that a grid model is produced.

The method can further include the step of detecting a radiation property and/or a reflection property and/or a degree of transparency and/or a color and/or a structure of the real object and providing this information to the step of generating the three-dimensional simulation model of the real scene. In this way, a so-called “emissive map” (also known as an “emission map”) can be generated. By generating and integrating such an emissive map in the creation of the three-dimensional simulation model of the real scene, an even more accurate image of the real scene can be produced, so that its influence on the virtual scene, and/or vice versa, can be implemented even more realistically.

The method can further include the step of assigning a corresponding three-dimensional object model to a detected real object and providing this model to the control device for generating the three-dimensional simulation model of the real scene. In particular, a transfer of a detected real object to the information for the simulation model of the real scene that is to be calculated, especially the detailed (realistic) detection of the real object, can be replaced by using an object model. This can be particularly relevant if a real object had been created based on an object model.

In a further aspect of the present invention, the object mentioned in the introduction is achieved by a device designed to match real and virtual content of a scene, wherein the device comprises:
at least one real light source in the real scene,
a control device designed to obtain and/or contain information about the at least one real light source, wherein the information includes at least one of the following: principal emission direction, emission cone, emission color spectrum and emission brightness of the at least one real light source,
a detection unit designed to detect a position of a real object in the real scene relative to the at least one real light source and/or the lighting situation of the real object in the real scene based on the light emitted by the at least one real light source,
wherein the control device is designed to generate a three-dimensional simulation model of the real scene, which includes at least one of the following: information about the at least one real light source, the position of the real object relative to the at least one real light source, and the lighting situation. of the real object,
a model generation unit designed to generate a three-dimensional model of a virtual scene that is suitable to be displayed on an image output unit with a suitable screen for the display,
wherein the model of the virtual scene includes at least information regarding a position of a virtual object relative to the screen,
a combination unit designed to combine the simulation model of the real scene with the model of the virtual scene, so that a transition from the real scene to the virtual scene takes place on the screen in such a way that the lighting situation of the real object is continued into the display of the virtual scene by the image output unit on the screen, and
a signal receiver designed to detect the real scene and the virtual scene at least section by section.

It should be explicitly noted at this point that all features, effects and advantages described in relation to the method according to the invention may also be at least partially applicable to the device according to the invention, and vice versa, and accordingly, for the description of the features, effects and advantages of the device according to the invention, reference is made to the description of the method according to the invention given above.

The device according to the invention can, for example, be further developed in such a way that the detection unit for detecting the position of the real object can be arranged in the screen of the image output unit or adjacent thereto. In this way, for example, the position of the real object relative to the screen of the image output unit can be detected directly without having to calculate the relative distance of the real object to the screen based on, for example, a relative position of the real object to the detection unit and a relative position of the screen to the detection unit.

Advantageously, the detection unit can comprise a multiplicity of cameras, which are arranged, in particular in a matrix configuration, on the screen of the image output unit, wherein the cameras can, in particular, together form a sparse light field array and be configured to capture the light field on the screen. It should be noted here that the term “detection” in this connection can also mean “determine, in particular estimate, based on the acquired information.” Such an arrangement of the detection unit on the screen of the output unit means that the light incident on the screen, in particular the entire lighting situation of the screen, can be captured directly on the screen.

The detection unit can comprise a plurality of cameras, in particular RGB cameras, which are configured to detect the real scene from different perspectives and/or different viewing directions. Reference is made in particular to the description above regarding the creation of the simulation model of the real scene using an AI-based computational method.

### BRIEF DESCRIPTION OF THE DRAWINGS

The present invention is described in greater detail hereinafter with the aid of an exemplary embodiment and with reference to the accompanying drawings, in which:

FIG. 1 shows a flowchart of an embodiment of the method according to the invention; and

FIGS. 2 and 3 show schematic views of lighting situations based on real and virtual light sources.

### DETAILED DESCRIPTION

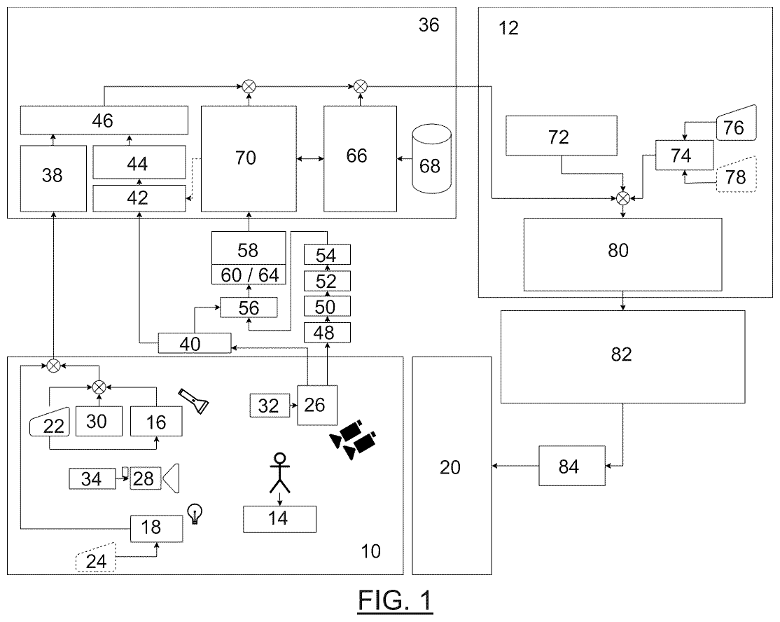

The method according to the invention is suitable for matching the content of a real scene 10 with the content of a virtual scene 12. The real scene 10 comprises, as such real content, a person 14, for example an actor, in the sense of a real object 14. In the real scene 10 the person 14 is illuminated by a first real light source 16 and a second real light source 18, so that the person 14 in the illustration according to FIG. 1 casts a shadow to the right in the direction of a screen 20 of an image output unit. The first real light source 16 can, for example, be a spotlight whose beam characteristics can be adjusted via an associated light console 22. The second real light source 18 can, for example, be a light bulb providing general room lighting, which can be adjusted, for example at least in its brightness, via an associated console 24, and/or can switched on and off.

In the embodiment shown in FIG. 1, the real scene 10 furthermore comprises a pair of cameras 26, which are configured to detect a position of the person 14 in the real scene 10, for example, relative to the first real light source 16, using a stereoscopic capture method. Alternatively or additionally, the pair of cameras 26 can also be configured to detect the lighting situation of the person 14 through the two real light sources 16 and 18.

Since the exemplary embodiment shown in FIG. 1 represents a film set for producing a movie, the real scene 10 also includes a production camera 28, which is configured to detect the person 14 and also sections of the screen 20 of the image output unit. For the sake of completeness, it should be mentioned that in certain film sequences it may also happen that the production camera 28 can detect exclusively only parts of the real scene 10 or exclusively only parts of the screen 20.

In the exemplary embodiment shown here, each of the first real light source 16, the camera pair 26, and the production camera 28 is connected to a respective tracking system 30, 32, 34, respectively, whereby this enables the position and/or orientation of the associated component to be detected in the real scene 10, for example, relative to the screen 20.

Information about the emission characteristics of the first real light source 16 as well as its position and/or orientation, the emission characteristics of the second real light source 18, and, if applicable, the position and/or orientation of the production camera 28, can be combined and provided as information for calculating a simulation model 36 of the real scene 10. The aforementioned information can be provided as a parametric luminaire model of the real light sources 38 for generating the simulation model 36.

Information that has been detected by the camera pair 26 can first be subjected to a color calibration 40 and then also provided as information for generating the simulation model 36. The information detected by the camera pair 26 can be used to first of all estimate the light sources in order to obtain, in addition to the parametric luminaire model of the real light sources 38, a parametric luminaire model of estimated light sources 44. The parametric luminaire model of real light sources 38 and the parametric luminaire model of estimated light sources 44 can then be combined to form a direct illumination model 46, which includes information on at least the light emission directions and/or the light intensities of the real light sources.

Secondly, the information detected via the camera pair 26 can first be subjected to a rectification 48, in particular a calibration 48, in which, for example, optical errors such as distortions and/or color deviations can be compensated for. The rectified information can then be subjected to a depth estimation 50 in order to be able to detect at least a distance of the real object 14 (here, the person 14) to the screen 20, in particular three-dimensional position data of the real object 14 in the real scene 10. For this purpose, in the exemplary embodiment shown in FIG. 1, points 52 of a point cloud can be used, whose three-dimensional position corresponds to respective points on a surface of the real object 14. These points 52 of the three-dimensional point cloud can then be connected to form a grid model 54. This three-dimensional grid model 54 can be combined with information from the color calibration 40 to form a color information grid model 56, in order to generate a so-called “emissive map” based on this information (also referred to as “emission map”). In this emissive map, areas of the three-dimensional grid model can be marked, for example, which are considered to be self-illuminating surfaces, and/or material properties can be assigned to a respective area of the three-dimensional mesh model that corresponds to a specific area of the real scene 10, in the same way as they correspond to the real scene 10. These material properties can, for example, correspond to information regarding a reflectivity, a diffusion, a transparency, a gloss level, a surface condition (e.g., surface roughness), and/or a normal direction to the respective area of the three-dimensional grid model. Optionally, the color information can also be assigned to the three-dimensional grid model in a separate “Colour Map” 60, and/or the surface information for the real object 14, in particular the reflection properties, can be assigned to the three-dimensional grid model in a separate “PBR Map” (“physically based rendering map”) 64.

In the embodiment shown in FIG. 1, it may be possible to retrieve three-dimensional object models 66 from an object database 68, so that it can be possible to use an already existing three-dimensional object model 66 that corresponds to the real object 14, instead of detecting a geometry of the real object 14. The detected and/or digitally available three-dimensional data of the real object 14 can be combined with at least the emission map 58 to form a digital image 70 of the real object 14. Based on this information, in particular of the digital image 70 of the real object 14 and the direct illumination model 46, a highly realistic simulation model 36 of the real scene 10 can thus be created.

As regards the virtual scene 12, a three-dimensional model 72 of the virtual scene 12 can be generated or already exists. For example, the three-dimensional model 72 of the virtual scene 12 can represent a landscape whose geometry and/or textures are known in detail. The virtual scene includes a virtual light source 74, such as the headlights of a virtual vehicle that is contained within the virtual scene 12. The emission characteristics of the virtual light source 74 can be adjusted via a first virtual console 76, for example, with regard to the brightness and/or color of the virtual light source, and via a second virtual light console 78, for example, with regard to the position and/or orientation of the virtual light source 74.

The simulation model 36 of the real scene 10, the three-dimensional model 72 of the virtual scene 12, and the information relating to the virtual light source 74 can now be combined in order to obtain a combined three-dimensional model 80. This combined three-dimensional model 80 can thus take into account both how the light emitted by the two real light sources 16 and 18, and possibly reflected or blocked by the real object 14, can have an affect on the lighting situation of the virtual scene 12, and how a lighting situation of the virtual scene 12, in particular based on the light emitted by the virtual light source 74 and reflected or cast in shadow by the three-dimensional model 72 of the virtual scene 12, can have an affect on the real scene 10. In order now to determine a correct representation of the virtual scene 12 on the screen 20 of the image output unit, especially as regards the relative position and/or orientation of the production camera 28 with respect to the screen 20, a situational combined three-dimensional model 82 can be calculated in a rendering process. This situational three-dimensional model 82 can now be displayed on the screen 20, which can be configured in particular as a light field image wall, using a processing unit 84 of the image output unit. A light field image wall allows directed light to be emitted onto the real scene 10 and thereby create a more realistic transition from the virtual scene 12 to the real scene 10.

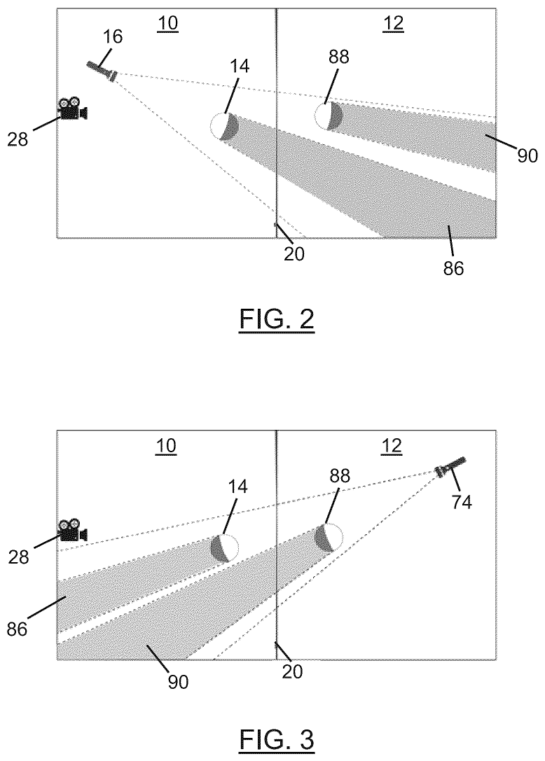

FIGS. 2 and 3 illustrate schematically and in a simplified manner the interaction of lighting situations.

Thus, in FIG. 2 the real light source 16 is shown on the same side as the real scene 10, and illuminates the real object 14, represented here in a simplified manner as a sphere. On the one hand it can be seen in FIG. 2 that a shadow 86, which is cast by the real object 14 due to the illumination by the real light source 16, extends seamlessly and in a realistic manner from the real scene 10 across the screen 20 into the virtual scene 12. On the other hand it can also be seen that the illumination from the real light source 16 from the real scene 10 is transferred to the virtual scene 12, so that a virtual object 88 also casts a shadow 90 due to the illumination from the real light source 16, which in the representation shown in FIG. 2 extends exclusively into the virtual scene 12.

Both the real object 14, with its lighting situation and shadow casting 86, and the virtual object 88, with its lighting situation and shadow casting 90, are detected by the production camera 28, so that for the viewer of the footage the transition between the real scene 10 and the virtual scene 12 is blurred.

Of course, instead of the production camera 28, a viewer could also be directly present in FIGS. 1 to 3, for whom the transition between the real scene 10 and the virtual scene 12 becomes blurred in a live presentation.

FIG. 3 now illustrates, in a manner similar to FIG. 2 but in reverse, how a virtual lighting situation affects the real scene 10.

For this purpose, a virtual light source 74 is arranged in the virtual scene 12, which illuminates both the virtual object 88 and, via the illumination properties of the screen 20 of the image output unit, the real object 14. The shadow 90 cast by the virtual object 88 extends seamlessly and realistically from the virtual scene 12 into the real scene 10. This can be achieved in particular if the screen 20 is provided with light emission units that are designed to emit directional light, so that the area of the shadow 90 in the real scene 10 is illuminated with a reduced light intensity compared to an area of the real scene 10 that is directly illuminated by the virtual light source 74. The illumination of the virtual light source 74 can also be transferred into the real scene 10 via the light emission property of the screen 20 in such a way that the real object 14 can be illuminated so that it casts the shadow 86 which, in the situation shown in FIG. 3, extends exclusively into the real scene 10.

1. Method for matching real and virtual content of a scene, wherein the method comprises the following steps:
providing at least one real light source in the real scene;
providing information about the at least one real light source to a control device, wherein the information comprises at least one of the following:
principal emission direction, emission cone, emission color spectrum and emission brightness of the at least one real light source;
detecting a position of a real object in the real scene relative to the at least one real light source and/or a lighting situation of the real object in the real scene, based on the light emitted by the at least one real light source;
generating, by means of the control device, a three-dimensional simulation model of the real scene, which comprises at least one of the following:
information about the at least one real light source, the position of the real object relative to the at least one real light source, and the lighting situation of the real object;
generating a three-dimensional model of a virtual scene that is suitable to be displayed at an image output unit with a screen suitable for the display, wherein the model of the virtual scene includes at least information regarding a position of a virtual object relative to the screen;
detecting a relative position of the screen with respect to the at least one real light source and/or to the real object;
combining the simulation model of the real scene with the mode of the virtual scene so that a transition from the real scene to the virtual scene takes place on the screen in such a way that the lighting situation of the real object in the representation of the virtual scene is continued by the image output unit on the screen; and
detecting the real scene and the virtual scene at least section by section by a signal receiver.

2. Method according to claim 1, wherein the step of detecting the position of the real object relative to the at least one real light source further comprises detecting a geometry of the real object, viewed at least from the perspective of the at least one real light source on the real object.

3. Method according to claim 1, wherein the information about the virtual object furthermore includes a geometry and/or a radiation property and/or a reflection property and/or a degree of transparency and/or a color and/or a structure of the virtual object.

4. Method according to claim 1, wherein the at least one real light source and/or the signal receiver and/or the real object is/are connected to a tracking system.

5. Method according to claim 1, wherein the step of detecting a position of a real object in the real scene comprises the use of a depth information detection device which is designed to detect depth information at least for sections of the real scene.

6. Method according to claim 5, wherein the depth information detection device comprises a stereoscopic camera pair, which in particular comprises at least one HDR camera, and/or a LiDAR unit and/or an RGB-D unit.

7. Method according to claim 5, wherein the depth information detection device is designed to employ a photogrammetric recording technique to generate the simulation model of the real scene.

8. Method according to claim 5, wherein the depth information detection device is designed to use an AI-based computational method, in particular NeRF or Gaussian splatting, to generate the simulation model of the real scene.

9. Method according to claim 5, wherein the depth information detection device is connected to a tracking system which is designed to enable a detection of the position and/or orientation of the depth information detection device relative to the screen and/or relative to the real object and/or relative to the at least one real light source, wherein the position and/or orientation of the depth information detection device forms part of the information for creating the simulation model of the real scene.

10. Method according to claim 1, further comprising the steps of:
providing a digital luminaire model of the at least one real light source, which includes information relating to at least one of the following: a principal emission direction, emission cone, emission color spectrum, and emission brightness of the at least one real light source; and
integrating the digital luminaire model in the step of generating the three-dimensional simulation model of the real scene.

11. Method according to claim 1, wherein the steps of the method are performed repeatedly, and wherein the method is designed to form images of changes in the real scene, particularly in real time, in the generation of an updated three-dimensional simulation model of the real scene and thus in an updated display of the virtual scene by the image output unit on the screen.

12. Method according to claim 1, wherein the image output unit comprises at least one of the following: a LED wall, a computer screen, a television screen and a projection wall, wherein the screen of the image output unit is in particular substantially planar or curved and/or has a rectangular, round, oval or polygonal outer contour.

13. Method according to claim 1, wherein the image output unit is designed to emit directional light, wherein, in particular, separate sections of the image output unit are configured to emit light in different directions in each case.

14. Method according to claim 13, wherein the image output unit is designed using light field technology, such that the image output unit is configured to emit corresponding directional light.

15. Method according to claim 1, wherein the step of detecting a position of a real object in the real scene comprises detecting a point cloud whose points are arranged at least on a surface of the real object, and/or detecting a grid model, wherein the grid model in its three-dimensional form is suitable, at least approximately depending on the mesh size of the grid model, to correspond to a surface of the real object.

16. Method according to claim 1, wherein the method further comprises the step of detecting a radiation property and/or a reflection property and/or a degree of transparency and/or a color and/or a structure of the real object, and providing this to the step of generating the three-dimensional simulation model of the real scene.

17. Method according to claim 1, wherein the method further comprises the step of assigning a corresponding three-dimensional object model to a detected real object and providing this to the control device for generating the three-dimensional simulation model of the real scene.

18. Device designed to match real and virtual contents of a scene, wherein the device comprises:
at least one real light source in the real scene;
a control device that is designed to receive and/or contain information about the at least one real light source, wherein the information comprises at least one of the following: a principal emission direction, emission cone, emission color spectrum and emission brightness of the at least one real light source;
a detection unit designed to detect a position of a real object in the real scene relative to the at least one real light source and/or a lighting situation of the real object in the real scene, based on the light emitted by the at least one real light source, wherein the control device is designed to generate a three-dimensional simulation model of the real scene which includes at least one of the following: information about the at least one real light source, the position of the real object relative to the at least one real light source, and the lighting situation of the real object;
a model generation unit which is designed to generate a three-dimensional model of a virtual scene that is suitable to be displayed at an image output unit with a screen suitable for the display, wherein the model of the virtual scene includes at least information regarding a position of a virtual object relative to the screen;
a combination unit which is designed to combine the simulation model of the real scene with the model of the virtual scene, so that a transition from the real scene to the virtual scene takes place on the screen in such a way that the lighting situation of the real object is continued into the representation of the virtual scene by the image output unit on the screen;
and
a signal receiver which is designed to detect the real scene and the virtual scene at least section by section.

19. Device according to claim 18, wherein the detection unit for detecting the position of the real object is arranged in the screen of the image output unit or adjacent thereto.

20. Device according to claim 1, wherein the detection unit comprises a plurality of cameras, which are arranged, in particular in a matrix arrangement, on the screen of the image output unit, wherein the cameras in particular together form a sparse light field arrangement and are configured to detect the light field in the screen.

21. Device according to claim 1, wherein the detection unit comprises a plurality of cameras, in particular RGB cameras, which are designed to detect the real scene from different perspectives and/or from different viewing directions.
